(19) United States
(12) Patent Application Publication
(10) Pub. No.: US 2026/0269223 A1
(43) Pub. Date: Sep. 10, 2026

(54) CATHODE ACTIVE MATERIALS FOR LITHIUM-ION BATTERIES AND METHODS OF MANUFACTURE

(71) Applicant: BASF SE, Ludwigshafen am Rhein (DE)

(72) Inventors: Bohang SONG, Solon, OH (US); Jacob HAAG, Beachwood, OH (US); James A. SIOSS, Beachwood, OH (US)

(21) Appl. No.: 19/166,525

(22) PCT Filed: Apr. 2, 2024
(86) PCT No.: PCT/EP2024/058830

§ 371 Date: Sep. 18, 2025

(30) Foreign Application Priority Data
Apr. 5, 2023 (EP) 23166691.8

(51) Int. Cl. H01M 4/36; H01M 4/02; H01M 4/131; H01M 4/525; H01M 4/58; H01M 4/62

(52) U.S. Cl. CPC H01M 4/366; H01M 4/131; H01M 4/525; H01M 4/5825; H01M 4/625; H01M 2004/028

(57) ABSTRACT

Disclosed herein are cathode active materials having
(A) a core material according to general formula Li₁₊ₓTM₁₋ₓO₂ where TM is a combination of Ni and Al and at least one of Mn and Co, and, optionally, at least one more metal selected from Mg, Zr, Ti, Nb, Ta, and W, and x is in the range of from zero to 0.2, where a least 80 mol-% of TM is nickel, and
(B) a coating that includes at least one compound of boron in the oxidation state of +III,
where the core material (A) is a polycrystalline material whose secondary particles are composed of primary particles,
and where 0.0009≤λ≤0.0024, with λ being the molar ratio of sulfate to TM, determined by Inductively Coupled Plasma spectroscopy (ICP).

The present invention is directed towards cathode active materials having
(A) a core material according to general formula Li₁₊ₓTM₁₋ₓO₂ wherein TM is a combination of Ni and Al and at least one of Mn and Co, and, optionally, at least one more metal selected from Mg, Zr, Ti, Nb, Ta, and W, and x is in the range of from zero to 0.2, wherein a least 80 mol-% of TM is nickel,
(B) a coating that comprises at least one compound of boron in the oxidation state of +III,
wherein said core material (A) is a polycrystalline material whose secondary particles are composed of primary particles, and which has a lattice constant ratio c/a of 4.9420 or less as determined by X-ray diffraction and Rietveld refinement,
and wherein 0.0009≤λ≤0.0024, with λ being the molar ratio of sulfate to TM, determined by Inductively Coupled Plasma spectroscopy (ICP), and wherein the sulfate concentration is essentially constant over the particle diameter of the secondary particles.

Lithium-ion secondary batteries are modern devices for storing energy. Many application fields have been and are contemplated, from small devices such as mobile phones and laptop computers through car batteries and other batteries for e-mobility. Various components of the batteries have a decisive role with respect to the performance of the battery such as the electrolyte, the electrode materials, and the separator. Particular attention has been paid to the cathode materials. Several materials have been suggested, such as lithium iron phosphates, lithium cobalt oxides, and lithium nickel cobalt manganese oxides. Although extensive research has been performed, the solutions found so far still leave room for improvement.

Currently, a certain interest in so-called Ni-rich cathode active materials may be observed, for example cathode active materials that contain 60 mol-% or more of Ni, referring to the total content of metals other than lithium.

Their electrochemical properties like first discharge capacity still leave room for improvement. It was an objective of the present invention to provide cathode active materials with a high electrochemical performance. In addition, it was an objective to provide cathode active materials with high specific capacity and low resistance growth upon cycling.

Accordingly, the cathode active materials as defined at the outset have been found, hereinafter also referred to as inventive cathode active materials or as cathode active materials according to the present invention. Inventive cathode active materials comprise a core (A) and a coating (B), hereinafter also referred to as (A) and (B), respectively. Core (A) and coating (B) will be described in more detail below.

Inventive cathode active materials comprise
(A) a core material according to general formula Li₁₊ₓTM₁₋ₓO₂ wherein TM is a combination of Ni and Al and at least one of Mn and Co, and, optionally, at least one more metal selected from Mg, Zr, Ti, Nb, Ta, and W, and x is in the range of from zero to 0.2, preferably 0.01 to 0.05, wherein a least 80 mol-% of TM is nickel, preferably at least 90 mol-%,
(B) a coating that comprises at least one compound of boron in the oxidation state of +III, for example LiBO₂, Li₂B₄O₇ or B₂O₃ or combination of at least two of the foregoing.
wherein said core material (A) is a polycrystalline material whose secondary particles are composed of primary particles, and core material (A) has a lattice constant ratio c/a of 4.9420 or less as determined by X-ray diffraction (“XRD”) and Rietveld refinement. Preferably, the lattice constant ratio c/a is below 4.9416. A minimum value is 4.9390. Preferably, the XRD analysis is performed with Cu-Kα radiation.

In one embodiment of the present invention, the lattice constant a is at least 2.8740 Å. Preferably, the lattice constant is in the range of from 2.8740 to 2.8765 Å.

In one embodiment of the present invention, the value of the unit cell of inventive cathode active materials is at least 101.60 Å³. A preferred upper limit is 101.80 Å³.

In one embodiment of the present invention core material (A) has an average particle diameter (D50) in the range of from 3 to 20 μm, preferably from 5 to 16 μm. The average particle diameter may be determined, e. g., by light scattering or LASER diffraction or electroacoustic spectroscopy. The secondary particles of core (A) are polycrystalline, that means that they are composed of a plurality of primary particles, and the above particle diameter refers to the secondary particle diameter.

In one embodiment of the present invention, core (A) has a monomodal particle diameter distribution. In another embodiment of the present invention, core (A) has a bimodal particle diameter distribution, with one maximum in the range of from 3 to 7 μm and one maximum in the range of from 9 to 15 μm.

In one embodiment of the present invention, core (A) has a narrow span of particle size distribution. The span may be expressed as (D90−D10)/(D50), and D90 and D10 are the respective percentile values.

Said polycrystalline core (A) is preferably composed of more than hundred primary particles per secondary particle, preferably more than 200 primary particles. The upper limit may be given as 5000 primary particles per secondary particle.

Said coating (B) may be continuous or have gaps, comparable to a Swiss cheese, or have an island structure, a Swiss cheese structure being preferred. “Swiss cheese” means that the majority of the surface is coated but with certain non-coated parts like holes. The average thickness of the coating may be determined by depth-profile XPS and is in the range of from 2 to 50 nm.

In one embodiment of the present invention, coating (B) is glassy or amorphous, and no crystalline phase may be detected by X-ray diffraction.

In inventive cathode active materials, 0.0009≤λ≤0.0024 and preferably 0.0009≤λ≤0.0020, with λ being the molar ratio of sulfate to TM, determined by Inductively Coupled Plasma spectroscopy (ICP). The sulfate concentration is essentially constant over the particle diameter of the secondary particles. Essentially constant means that any deviation in an analysis performed by depth-profile XPS, the deviation of the local sulfate concentration is 10 mol-% or less, and—preferably—no clear gradient may be detected.

In one embodiment of the present invention, TM is a combination of metals according to general formula (I)

(NiₐCo_{b}Mn_{c}Al_{d})₁₋ₑMₑ (I)
with
a being in the range of from 0.90 to 0.98, preferably 0.91 to 0.95,
b being in the range of from 0.005 to 0.09, preferably 0.01 to 0.05,
c being in the range of from 0.005 to 0.09, preferably 0.01 to 0.05,
d being in the range of from 0.001 to 0.05, and
e being in the range of from zero to 0.05,
M is selected from Mg, Ti, Zr, Nb, Ta, and W, and

$$a + b + c + d = 1 .$$

In one embodiment of the present invention, M is selected from Ti, Zr, Mg, and combinations like Zr and Ti, Zr and Mg and, in particular, Zr and Ti and Mg.

Some elements are ubiquitous. In the context of the present invention, traces of ubiquitous metals such as sodium, calcium, iron or zinc, as impurities will not be taken into account in the description of the present invention. Traces in this context will mean amounts of 0.05 mol-% or less, referring to the total metal content of the TM or of particles (B), respectively.

In one embodiment of the present invention, cobalt is essentially uniformly distributed over the radius of the secondary particles of core (A). Preferably, cobalt is essentially uniformly distributed over the radius of the primary particles of core (A). “Essentially uniformly” means in this context that any deviation in an analysis performed by depth-profile XPS, the deviation of the local cobalt concentration is 10 mol-% or less, referring to the average cobalt concentration, and—preferably—no clear gradient may be detected.

In one embodiment of the present invention, inventive cathode active material has an average diameter of the primary particles in the range of from 300 to 500 nm, determined by SEM. In the case of rod-shaped primary particles, the average diameter refers to the length of said primary particles.

In one embodiment of the present invention, inventive cathode active material has a porosity in the range of from 1.5 to 5.0% by volume determined by analysis of cross section images made with TEM and SEM. The porosity refers to gaps between primary particles in a secondary particle.

In one embodiment of the present invention, the centers of secondary particles of core (A) comprise spheroidal primary particles and the outer part of the of core (A) comprises rod-shaped primary particles. This means that the majority of the center of core (A) is occupied by spheroidal primary particles and the majority of the outer part of core (A) is occupied by rod-shaped primary particles.

Preferably, the rod-shaped primary particles in the outer part of core (A) are essentially radially oriented. The term “essentially radially” includes but is not limited to particles with a perfect radial orientation. It includes that in an SEM analysis, of at least 80% of the primary rod-shaped particles in at least 50 randomly selected secondary particles, the deviation to a perfectly radial orientation is at most 8 degrees.

Furthermore, at least 60% of the secondary particle volume is filled with radially oriented primary particles. Preferably, only a minor inner part, for example at most 40%, preferably at most 20%, of the volume of those particles is filled with non-radially oriented primary particles, for example, in random orientation.

The above properties essentially persist after having added the coating (B). Essentially means that changes if applicable are less than 10% or within experimental error.

In one embodiment of the present invention, inventive cathode active material has an amount of residual lithium on its surface in the range of from 0.05 to 0.5 wt-%, determined by titration.

In one embodiment of the present invention, inventive cathode active material has a specific surface (BET) in the range of from 0.4 to 0.9 m²/g, preferably 0.5 to 0.7 m²/g, determined according to DIN-ISO 9277:2003-05.

Inventive cathode active materials display an excellent electrochemical behaviour. In particular, they exhibit a high first discharge capacity, a good cyclability, and a low resistance growth.

The present invention further relates to a process for manufacturing inventive cathode active materials, hereinafter also referred to as “inventive process” or “process according to the (present) invention”.

The inventive process comprises at least five steps, (a), (b), (c), (d) and (e), in the context of the present invention also referred to as step (a) and step (b) and step (c) and step (d) and step (e), respectively. Steps (a) and (b) and (d) and (e) are performed subsequently. Steps (b) and (c) may be performed consecutively or simultaneously.

The inventive process comprising the steps of
(a) providing an oxide of TM′ wherein TM′ is like TM but without the aluminum as added in step (b),
(b) mixing said oxide of TM′ with Al₂(SO₄)₃ and Al(OH)₃ and a source of lithium, and, optionally, with at least one oxide or (oxy) hydroxide of Mg, Zr, Ti, Nb, Ta, and W,
(c) calcining the mixture obtained in step (b) at a temperature in the range of from 650 to 800° C., thereby obtaining a powder,
(d) washing the powder from step (c) with an aqueous medium, followed by separating the washed powder from the wash water by a solid-liquid separation method, thereby obtaining a residue, and
(e) adding a boron compound with boron in the oxidation state of +III to the residue obtained in step (d), followed by drying and a heat treatment at a temperature in the range of from 250 to 400° C.

Steps (a) to (e) will be explained in more detail below.

The inventive process starts off from a precursor for a cathode active material. The precursor is an oxide of TM′. TM′ is similar to TM but without the aluminum as added in step (b). Thus, TM′ is a combination of Ni and at least one of Mn and Co, and, optionally, at least one more metal selected from Mg, Al, Ti, Zr, Nb, Ta, and W, and the nickel content is in the range of from 80 to 99 mol-% of TM′ if the Al from step (b) may be neglected. Said precursor may hereinafter also be referred to as “starting material”.

In one embodiment of the present invention, the precursor has an average particle diameter (D50) in the range of from 3 to 20 μm, preferably from 5 to 16 μm. The average particle diameter may be determined, e. g., by light scattering or LASER diffraction or electroacoustic spectroscopy. The particles are usually composed of agglomerates from primary particles, and the above particle diameter refers to the secondary particle diameter.

In one embodiment of the present invention, the precursor has a monomodal particle diameter distribution. In another embodiment of the present invention, the precursor has a bimodal particle diameter distribution.

In one embodiment of the present invention, the precursor has a narrow span of particle size distribution. The span may be expressed as (D90−D10)/(D50), and D90 and D10 are the respective percentile values.

In one embodiment of the present invention, the precursor has a specific surface (hereinafter also referred to as BET surface) in the range of from 50 to 250 m²/g. The BET surface may be determined by nitrogen adsorption after outgassing of the sample at 120° C. for 30 minutes or more and beyond this in accordance with DIN ISO 9277:2010.

In one embodiment of the present invention, in step (a), an oxide of TM′ with a moisture content in the range of from zero to 100 ppm, is provided, determined by Karl-Fischer titration, preferred are 1 to 50 ppm. In this context, zero means “below detection level”.

TM′ in the above formula contains at least one of Mn and Co, and preferably both Mn and Co.

Optionally, TM′ may contain at least one more metal selected from Mg, Al, Ti, Zr, Nb, Ta, and W.

In one embodiment of the present invention, TM′ is a combination of metals according to general formula (I a)

(NiₐCo_{b}Mn_{c})₁₋ₑM*ₑ (I a)
wherein
a being in the range of from 0.90 to 0.98, preferably 0.91 to 0.95,
b being in the range of from 0.005 to 0.09, preferably 0.01 to 0.05,
c being in the range of from 0.005 to 0.09, preferably 0.01 to 0.05,
e being in the range of from zero to 0.05,

$$a + b + c = 1 - d , with 0.001 \leq d \leq 0.05$$

M* being selected from at least one of Mg, Al, Ti, Zr, Nb, Ta, and W, preferably from at least one of Mg, Ti, Zr, Nb, Ta, and W.

Precursor as provided in step (a) is usually free from conductive carbon, that means that the conductive carbon content of precursor is less than 1% by weight, referring to said starting material, preferably 0.001 to 1.0% by weight.

Precursor as provided in step (a) usually free from lithium. That means that the lithium content in precursor provided in step (a) is lower than 0.1% by weight, referring to precursor, preferably in the range of from zero to 100 ppm. Lithium compounds in the starting material are usually impurities.

Again, some elements are ubiquitous. In the context of the present invention, traces of ubiquitous metals such as sodium, calcium, iron or zinc, as impurities will not be taken into account. Traces in this context will mean amounts of 0.005 mol-% or less, referring to the total metal content of TM. Sulfate that may stem from the precursor manufacture will be neglected as well.

In step (b), oxide of TM′ is mixed with a source of lithium and with Al₂(SO₄)₃ and, optionally, with Al(OH)₃, and, optionally, with at least one oxide or (oxy) hydroxide of Mg, Zr, Ti, Nb, Ta, and W.

Examples of optionally added oxide or hydroxide or oxyhydroxide of Ti, Zr, W, Ta, or Mg or Nb are TiO₂, Ti₂O₃, TiO(OH)₂, TiO₂·aq, ZrO₂, Zr(OH)₄, and ZrO₂·aq as well as WO₃, Li₂WO₄, Ta₂O₅, Nb₂O₅ and Nb₂O₅·aq (“niobic acid”).

Suitable sources of lithium are LiOH, with or with hydrate, Li₂CO₃, and Li₂O₂ and mixtures of at least two of the foregoing, for example mixtures of LiOH and Li₂O₂.

The amount of source of lithium is preferably selected in a way that the overall molar ratio of lithium to metals other than lithium corresponds to (1+x+y)/(1−x) wherein x is in the range of from zero to 0.05, and y is in the range of from zero to 0.1. The variable y takes into account that during step (c), some lithium may be lost through sublimation.

In one embodiment of the present invention, the molar ratio of Al to TM′ in step (b) is in the range of from 0.001 to 0.05.

In one embodiment of the present invention, in step (b), Al(OH)₃ and Al₂(SO₄)₃ are applied in a molar ratio in the range of from 2:1 to 1:5.

Al₂SO₄ may be applied as water-free aluminum sulfate or as hydrate.

In one embodiment of the present invention, step (b) is performed by charging a vessel with starting material provided in step (a) and adding source of lithium and Al₂(SO₄)₃ and Al(OH)₃. The order of addition of source of lithium and Al₂(SO₄)₃ and Al(OH)₃ is not critical.

Step (c) includes calcining the mixture obtained from step (b), for example at a temperature in the range of from 550 to 800° C., preferably 575 to 775° C.

Step (c) may be carried out in any type of oven, for example a roller hearth kiln, a pusher kiln, a rotary kiln, a pendulum kiln, or—for lab scale trials—in a muffle oven.

The temperature of 650 to 800° C. corresponds to the maximum temperature of step (c).

It is possible to subject the mixture obtained from step (b) directly to step (c). However, it is preferred to increase the temperature stepwise, or to ramp up the temperature. Said step-wise increase or ramping up may be performed under normal pressure or under reduced pressure, for example 1 to 500 mbar.

Step (c)—at its maximum temperature—may be performed under normal pressure.

Step (c) is carried out under an oxygen-containing atmosphere, for oxygen-enriched air with at least 80 vol-% of oxygen, or under pure oxygen.

In one embodiment of the present invention, step (c) is carried out under an atmosphere with reduced CO₂ content, e.g., a carbon dioxide content in the range of from 0.01 to 500 ppm by weight, preferred are 0.1 to 50 ppm by weight. The CO₂ content may be determined by, e.g., optical methods using infrared light. It is even more preferred to perform step (d) under an atmosphere with a carbon dioxide content below detection limit for example with infrared light-based optical methods.

In one embodiment of the present invention, step (c) is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, step (c) of the present invention is performed under a forced flow of gas, for example air, oxygen and oxygen-enriched air. Such stream of gas may be termed a forced gas flow. Such stream of gas may have a specific flow rate in the range of from 0.5 to 15 m³/h·kg mixture from step (b). The volume is determined under normal conditions: 298 Kelvin and 1 atmosphere. Said forced flow of gas is useful for removal of gaseous cleavage products such as water.

In one embodiment of the present invention, step (c) has a duration in the range of from two to 30 hours. Preferred are 6 to 24 hours. The cooling time is neglected in this context. In step (c), a powder is obtained that may be deagglomerated after cooling.

In step (d), said powder obtained from step (c) is treated with an aqueous medium, preferably with water or with an aqueous solution of LiOH. Said aqueous medium may have a pH value in the range of from 7 up to 14, preferably at least 3.5, more preferably from 5 to 7 or 10 to 13. The pH value is measured at the beginning of step (d). It is observed that in the course of step (d), the pH value raises to at least 10, for example 11 to 13. In embodiments wherein the pH value is in the range of from 10 to 11 at the beginning of step (d) it raises to more than 11 to up to 13.

In embodiments wherein the pH value is in the range of 3 to below 10 at the beginning of step (d) it raises to 11 to up to 13 in the course of step (d).

It is preferred that the water hardness of said aqueous medium used in step (d) is at least partially removed, especially calcium. The use of desalinized water is preferred.

The pH value of said aqueous medium is influenced by substances dissolved or slurried in said aqueous medium, for example acidic compounds such as sulfuric acid or aluminum sulfate, or bases such as LiOH or NaOH. In a preferred embodiment, such aqueous medium is water.

In one embodiment of the present invention, step (d) is performed at a temperature in the range of from 5 to 85° C., preferred are 5 to 30° C.

In one embodiment of the present invention, step (d) is performed at normal pressure. It is preferred, though, to perform step (d) under elevated pressure, for example at 10 mbar to 10 bar above normal pressure, or with suction, for example 50 to 250 mbar below normal pressure, preferably 100 to 200 mbar below normal pressure.

Step (d) may be performed, for example, in a vessel that can be easily discharged, for example due to its location above a filter device. Such vessel may be charged with material from step (d) followed by introduction of aqueous medium. In another embodiment, such vessel is charged with aqueous medium followed by introduction of material from step (d). In another embodiment, material from step (d) and aqueous medium are introduced simultaneously.

In one embodiment of the present invention, in step (d), the amounts of water and electrode active material have a weight ratio in the range of from 1:5 to 5:1, preferably from 2:1 to 1:2.

Step (d) may be supported by mixing operations, for example shaking or in particular by stirring or shearing, see below.

In one embodiment of the present invention, step (d) has a duration in the range of from 1 minute to 90 minutes, preferably 1 minute to less than 60 minutes. A duration of 5 minutes or more is possible in embodiments wherein in step (d), water treatment and water removal are performed overlapping or simultaneously.

In one embodiment of the present invention, treatment according to step (d) and removal of the aqueous medium are performed consecutively.

After or during the treatment with an aqueous medium in accordance to step (d), water may be removed by any type of filtration, for example on a band filter or in a filter press.

In one embodiment of the present invention, at the latest 5 minutes after commencement of step (d), the removal of aqueous medium is started. Such removal includes partially removing the water from treated particulate electrode active material, for example by way of a solid-liquid separation, for example by decanting or preferably by filtration. Said “partial removal” may also be referred to as partially separating off.

In one embodiment of the present invention, the slurry obtained in step (d) is discharged directly into a centrifuge, for example a decanter centrifuge or a filter centrifuge, or on a filter device, for example a suction filter or in a filter press or in a belt filter that is located preferably directly below the vessel in which step (b) is performed. Then, filtration is commenced.

In a particularly preferred embodiment of the present invention, step (d) and the removal of the aqueous medium are performed in a filter press or in a filter device with stirrer, for example a pressure filter with stirrer or a suction filter with stirrer (German for example: “Rührfilter-nutsche”). At most 5 minutes after, preferably at most 3 minutes after—or even immediately after—having combined starting material and aqueous medium in accordance with step (d), removal of aqueous medium is commenced by starting the filtration. On laboratory scale, treatment with and removal of the aqueous medium may be performed on a Büchner funnel be supported by manual stirring.

In a preferred embodiment, step (d) is performed in a filter device, for example a stirred filter device that allows stirring of the slurry in the filter or of the filter cake.

In one embodiment of the present invention, the aqueous medium or water removal in accordance with step (d) has a duration in the range of from 1 minute to 1 hour.

In one embodiment of the present invention, stirring in step (d) is performed with a rate in the range of from 1 to 50 revolutions per minute (“rpm”), preferred are 5 to 20 rpm. In other embodiments, it is 200 to 400 rpm.

In one embodiment of the present invention, filter media may be selected from ceramics, sintered glass, sintered metals, organic polymer films, non-wovens, and fabrics.

In one embodiment of the present invention, step (d) is carried out under an atmosphere with reduced CO₂ content, e.g., a carbon dioxide content in the range of from 0.01 to 500 ppm by weight, preferred are 0.1 to 50 ppm by weight. The CO₂ content may be determined by, e.g., optical methods using infrared light. It is even more preferred to perform step (d) under an atmosphere with a carbon dioxide content below detection limit for example with infrared-light based optical methods.

From step (d), a solid residue is obtained, preferably in the form of a wet filter cake. The moisture content of the solid residue and especially of the filter cake may be in the range of from 3 to 20% by weight, preferably 4 to 9% by weight.

After step (d), drying may be performed, for example under nitrogen or under reduced pressure (“in vacuo”) at 50 to 150° C., to obtain a free-flowing powder.

Step (e) includes adding a compound of B in the oxidation state of (+III) to the residue obtained in step (d) and performing a thermal treatment at a temperature in the range of from 250 to 400° C.

Examples of compounds of boron in the oxidation state of (+III) are B₂O₃, boric acid (B(OH)₃ and lithium borates, for example LiBO₂. Boric acid is preferred. Said compound of boron may be added in bulk or in solution, for example as aqueous solution.

In a preferred embodiment, step (d) is performed as indicated above but with no drying, and a compound of boron is added to the moist or even wet filter cake.

In one embodiment of the present invention, the residue obtained from step (d) is allowed to interact, for example in the range of from 10 minutes to 5 hours and at a temperature of from 5 to 85° C.

In one embodiment of the present invention, the amount of boron added in step (e) is in the range of from 0.05 to 1.5 mol-%, preferably 0.15 to 0.9 mol-%, referring to TM.

Subsequently to the addition of compound of boron a heat treatment is performed. Said heat treatment may be carried out in any type of oven, for example a roller hearth kiln, a pusher kiln, a rotary kiln, a pendulum kiln, or—for lab scale trials—in a muffle oven.

The temperature of said heat treatment in step (e) may be in the range of from 250 to 400° C. Said temperature refers to the maximum temperature of step (e).

In one embodiment of the present invention, the temperature is ramped up before reaching the desired temperature of from 250 to 400° C. For example, first the mixture of step (e) is heated to a temperature to 250 to 300° C. and then held constant for a time of 10 min to 4 hours, and then it is raised to 325 to 400° C.

In one embodiment of the present invention, the heating rate in step (e) is in the range of from 0.1 to 10° C./min.

In one embodiment of the present invention, the heat treatment step (e) is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, the heat treatment in step (e) is performed in an oxygen-containing atmosphere, for example in a nitrogen-air mixture, in a rare gas-oxygen mixture, in air, in oxygen or in oxygen-enriched air or in pure oxygen. In a preferred embodiment, the atmosphere in step (e) is selected from air, oxygen and oxygen-enriched air. Oxygen-enriched air may be, for example, a 50:50 by volume mix of air and oxygen. Other options are 1:2 by volume mixtures of air and oxygen, 1:3 by volume mixtures of air and oxygen, 2:1 by volume mixtures of air and oxygen, and 3:1 by volume mixtures of air and oxygen. Pure oxygen is even more preferred.

In one embodiment of the present invention, the heat treatment in step (e) has a duration in the range of from 30 minutes to 5 hours. Preferred are 60 minutes to 4 hours. The cooling time is neglected in this context.

By carrying out the inventive process, inventive cathode active material is obtained.

A further aspect of the present invention refers to electrodes comprising at least one electrode material active according to the present invention. They are particularly useful for lithium-ion batteries. Lithium-ion batteries comprising at least one electrode according to the present invention exhibit a good discharge behavior. Electrodes comprising at least one cathode active material according to the present invention are hereinafter also referred to as inventive cathodes or cathodes according to the present invention.

In one embodiment of the present invention, inventive electrodes contain
(A) at least one inventive cathode active material,
(B) carbon in electrically conductive form and
(C) a binder.

In a preferred embodiment of the present invention, inventive cathodes contain
(A) 80 to 99% by weight inventive cathode active material,
(B) 0.5 to 19.5% by weight of carbon,
(C) 0.5 to 9.5% by weight of binder polymer, percentages referring to the sum of (A), (B) and (C).

A further aspect of the present invention is directed to a secondary battery containing
(1) at least one electrode according to claim 13,
(2) at least one anode, and
(3) an electrolyte.

Cathodes according to the present invention can comprise further components. They can comprise a current collector, such as, but not limited to, an aluminum foil. They can further comprise conductive carbon and a binder.

Cathodes according to the present invention contain carbon in electrically conductive modification, in brief also referred to as carbon (B). Carbon (B) can be selected from soot, active carbon, carbon nanotubes, graphene, and graphite. Carbon (B) can be added as such during preparation of cathode active materials according to the invention.

Suitable binders (C) are preferably selected from organic (co)polymers. Suitable (co)polymers, i.e., homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binder is selected from those (co)polymers which have an average molecular weight M_{w} in the range from 50,000 to 1,000,000 g/mol, preferably to 500,000 g/mol.

Binder may be cross-linked or non-cross-linked (co)polymers.

In a particularly preferred embodiment of the present invention, binder is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to cathode active material. In other embodiments, inventive cathodes may comprise 0.1 up to less than 1% by weight of binder(s).

A further aspect of the present invention is a battery, containing at least one cathode comprising inventive cathode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5 000 000 g/mol, preferably up to 2 000 000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

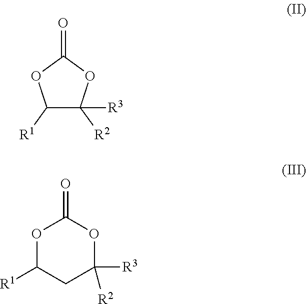

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

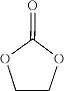

The solvent or solvents is/are preferably used in the water-free state, i.e. with a water content in the range from 1 ppm to 0.1% by weight, which can be determined, for example, by Karl-Fischer titration.

Electrolyte (C) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In an embodiment of the present invention, batteries according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero° C. or below, for example down to −10° C. or even less), a very good discharge and cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further relates to the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by the following working examples.

Percentages are % by weight unless specifically denoted otherwise. RPM: rounds per minute

Percentages are % by weight unless specifically denoted otherwise. RPM: rounds per minute

### I. Cathode Active Materials

### I.1. Preparation of Precursor

A stirred tank reactor was filled with deionized water with ammonium sulfate added (49 g per kg water). The solution was controlled to be 55° C. and pH value to be 12 by adding aqueous sodium hydroxide solution.

The stirred tank reactor was simultaneously fed with an aqueous transition metal sulfate solution and aqueous sodium hydroxide solution at a flow rate ratio of 1.8, and a total flow rate resulting in a residence time of 8 hours. The transition metal sulfate solution contained Ni, Co, Mn in a molar ratio of 94:3:3 and the total transition metal concentration was 1.65 mol/kg. The aqueous sodium hydroxide solution was a mixture between sodium hydroxide solution (25 wt. %) and ammonia solution (25 wt. %) in a weight ratio of 6. The pH value 12 was kept by a separate feed of aqueous sodium hydroxide solution. Beginning with the start-up of all feeds, mother liquor was continuously removed. After 27 hours all feed flows were stopped. The mixed transition metal (TM) oxyhydroxide precursor TM-OH. 1 was obtained by filtration of resulting suspension, washing with distilled water, drying at 120° C. in air, and sieving.

The oxyhydroxide precursor TM-OH. 1 obtained was then calcined at 475° C. to produce the oxide precursor TM-O.1.

### I.2. Preparation of Cathode Active Materials (Pristine)

The oxide precursor TM-O.1 was mixed with 0.5 mole-% anhydrous Al₂(SO₄)₃, 0.7 mole-% Al(OH)₃, and 0.3 mole-% ZrO₂, all mole-% referring to the sum of Ni, Co, and Mn in TM-O.1, and with anhydrous LiOH with a Li/TM molar ratio of 1.03. The mixture was heated to 765° C. for 8 hours in a forced flow of oxygen to obtain the cathode active material B-CAM.1.I

In a comparative example, the same mixture was made except that the 1.2 mole-% Al(OH)₃ was added without addition of Al₂(SO₄)₃. After calcining the mixture, cathode active material C-CAM.2 was obtained.

D50=13.0 μm measured by laser diffraction technique in a Mastersizer 3000 instrument from Malvern Instruments. Residual moisture 140 ppm was determined at 230° C.

### I.3. Post Treatment Processes

### I.3.1. Washing Step

The cathode active material according to I.2. was contacted with deionized water for 5 minutes during stirring. The weight ratio of cathode active material over water was 2000 g/L. The washed cathode active material CAM.W.1(2) was obtained by filtration of resulting slurry followed by drying at 120° C. in air.

### I.3.2. Coating Step

The washed cathode active material CAM.W.1(2) obtained according to I.3.1. was mixed with 0.9 mole-% H₃BO₃ in a roller mill. The mole-% referred to the sum of Ni, Co, and Mn in the CAM.W.1 (2). The mixture was then heated at 300° C. for 5.5 hours in a forced flow of oxygen to obtain the cathode active material CAM.1 or C-CAM.2, respectively.

Rietveld refinement based on XRD pattern (Cu-Kα radiation, λ=1.540596 Å) of CAM.1 revealed: lattice constant a=2.8750 Å and lattice constant c=14.207 Å and c/a=4.9416.

For C-CAM.2, the lattice constants a=2.8738 Å and c=14.205 Å, and the ratio of lattice constants c/a is 4.9429.

ICP analysis revealed λ=0.0016 for CAM.1 and λ=0.0007 for C-CAM.2.

Depth profile XPS revealed a sulfur concentration gradient from outmost surface (1.4 mol % of all elements detected) towards bulk center and stabilized at 500 nm and beyond (0.4 mol %) for B-CAM.1. Depth profile XPS also revealed for CAM.1, 0.4 mol % sulfur is detected from outmost surface towards 300 nm depth without obvious gradient and can no longer be detected beyond 300 nm depth.

Surface XPS measurement revealed a formation of LiBO₂/Li₂B₄O₇ at the particle surface of CAM.1 and C-CAM.2.

Cross section TEM-EDX revealed that for B-CAM.1, sulfur is enriched at grain boundaries between primary particles wherein the primary particles are located at the surface and the bulk center of secondary particles. For CAM.1, sulfur enrichment at grain boundaries is no longer detectable at the surface and the bulk center of secondary particles.

Cross section SEM imaging revealed a 4.0% porosity of secondary particles of CAM.1. In contrast, C-CAM.2 only has 1.5% porosity. Higher porosity enables more efficient injection of electrolyte into the pores and faster transportation of Li⁺ ions, and thus leading to a higher capacity.

### II. Testing of Cathode Active Material

### II. 1. Electrode Preparation, General Procedure

### II. 1.1. Cathode Preparation

PVDF binder (Solef® 5130) was dissolved in NMP (Merck) to produce a 7.5 wt. % solution. For electrode preparation, binder solution (3 wt. %), graphite (SFG6L, 2 wt. %), and carbon black (Super C65, 1 wt. %) were suspended in NMP. After mixing using a planetary centrifugal mixer (ARE-250, Thinky Corp., Japan), either inventive CAM.1 or comparative cathode active material C-CAM.2 (94 wt. %) was added and the suspension was mixed again to obtain a lump-free slurry. The solid content of the slurry was adjusted to 65%. The slurry was coated onto Al foil using a roll-to-roll coater. Prior to use, all electrodes were calendared. The thickness of cathode material was 70 μm, corresponding to 15 mg/cm². All electrodes were dried at 105° C. for 7 hours before battery assembly.

### II.2. Electrolyte Preparation

A base electrolyte was prepared by mixing 12.7 wt. % LiPF₆, 26.2 wt. % ethylene carbonate (EC), and 61.1 wt. % ethyl methyl carbonate (EMC) (EL base 1), based on the total weight of EL base 1.

### II.3 Test Cell Manufacture

### II.3.1. Coin-Type Half Cells

Coin-type half cells (20 mm in diameter and 3.2 mm in thickness) comprising a cathode prepared as described under II.1.1 and lithium metal as working and counter electrode, respectively, were assembled in an Ar-filled glove box. The cathode, anode, and separator were superposed in order of cathode//separator//Li foil to produce a half coin cell. Thereafter, 0.15 mL of EL base 1 as described under II.2 were added into the coin cell.

### III. Evaluation of Cell Performance

Cell performance was evaluated in coin-type half cells. Coin-type half cells as described under II.3.1 were tested in a voltage window between 4.3 and 2.7V at ambient temperature. For the initial cycles, the de-lithiation was conducted in a CC-CV mode, i.e., a constant current (CC) of 0.05 C was applied followed by holding constant voltage (CV) at 4.3V until reaching 0.02 C. After 5 min resting, re-lithiation was carried out at a constant current of 0.05 C to 2.7V. For the cycling, the current density is C/3. The results were summarized in Table 1.

TABLE 1
Coin-type half cell performance

| | | | | Capacity |
|---|---|---|---|---|
| | Initial | Initial | | Retention |
| | Charge Cap. | Discharge Cap. | C.E. | after 50 |
| Material | [mAh/g] | [mAh/g] | [%] | Cycles [%] |
| CAM.1 | 245 | 230 | 94 | 91 |
| C-CAM.2 | 243 | 226 | 93 | 86 |

1. A cathode active material comprising:
(A) a core material according to general formula Li₁₊ₓTM₁₋ₓO₂ wherein TM is a combination of Ni and Al and at least one of Mn and Co, and, optionally, at least one more metal selected from the group consisting of Mg, Zr, Ti, Nb, Ta, and W, and x is in the range of from zero to 0.2, wherein a least 80 mol-% of TM is nickel, and
(B) a coating that comprises at least one compound of boron in the oxidation state of +III,
wherein said core material (A) is a polycrystalline material whose secondary particles are composed of primary particles, and which has a lattice constant ratio c/a of 4.9420 or less as determined by X-ray diffraction and Rietveld refinement,
and wherein 0.0009≤λ≤0.0024, with λ being the molar ratio of sulfate to TM, determined by Inductively Coupled Plasma spectroscopy (ICP), and wherein the sulfate concentration is essentially constant over the particle diameter of the secondary particles.

2. The cathode active material according to claim 1, wherein TM is a combination of metals according to general formula (I)
(NiₐCo_{b}Mn_{c}Al_{d})₁₋ₑMₑ (I)
with
a being in the range of from 0.9 to 0.98,
b being in the range of from 0.005 to 0.09,
c being in the range of from 0.005 to 0.09,
d being in the range of from 0.001 to 0.05, and
e being in the range of from zero to 0.05,
wherein M is selected from the group consisting of Mg, Ti, Zr, Nb, Ta, and W, and
$$a + b + c + d = 1 .$$

3. The cathode active material according to claim 1, wherein said coating comprises LiBO₂, Li₂B₄O₇ or B₂O₃.

4. The cathode active material according to claim 1, wherein cobalt is essentially uniformly distributed over the radius of the secondary particles.

5. The cathode active material according to claim 1, wherein said cathode active material has an average diameter of the primary particles in the range of from 300 to 500 nm, determined by SEM.

6. The cathode active material according to claim 1, having a porosity in the range of from 1.5 to 5.0% by volume determined by analysis of cross section images made with TEM and SEM.

7. The cathode active material according to claim 1, wherein the center of core (A) comprises spheroidal primary particles and the outer part of the of core (A) comprises rod-shaped primary particles.

8. Process A process for making cathode active material according to claim 1, comprising the steps of:
(a) providing an oxide of TM′ wherein TM′ is TM but without the aluminum as added in step (b),
(b) mixing said oxide of TM′ with a source of lithium and with Al₂(SO₄)₃ and, optionally, with Al(OH)₃, and, optionally, with at least one oxide or (oxy) hydroxide of Mg, Zr, Ti, Nb, Ta, and W,
(c) calcining the mixture obtained in step (b) at a temperature in the range of from 650 to 800° C., thereby obtaining a powder,
(d) washing the powder from step (c) with an aqueous medium, followed by separating the washed powder from the wash water by a solid-liquid separation method, and
(e) adding a boron compound with boron in the oxidation state of +III to the solid obtained in step (d), followed by drying and a heat treatment at a temperature in the range of from 250 to 400° C.

9. The process according to claim 8, wherein the molar ratio of Al to TM′ in step (b) is in the range of from 0.001 to 0.05.

10. The process according to claim 8, wherein step (d) is performed at a temperature in the range of from zero to 30° C.

11. The process according to claim 8, wherein step (d) comprises a filtration as solid-liquid separation method, and in step (e), boric acid is added to the filter cake.

12. The process according to claim 8, wherein in step (b), Al(OH)₃ and Al₂(SO₄)₃ are applied in a molar ratio in the range of from 2:1 to 1:5.

13. An electrode containing
(A) at least one electrode active material according to claim 1,
(B) carbon in electrically conductive form and
(C) a binder.

14. A secondary battery containing
(1) at least one electrode according to claim 13,
(2) at least one anode, and
(3) an electrolyte.
